(19) United States
(12) Patent Application Publication
(10) Pub. No.: US 2005/0097993 A1
(43) Pub. Date: May 12, 2005

(54) Gripping apparatus

(76) Inventor: David Niven, New Plymouth (NZ)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 10/496,717

(22) PCT Filed: Nov. 26, 2002
(86) PCT No.: PCT/GB02/05320

(30) Foreign Application Priority Data
Dec. 4, 2001 (NZ) 515919

(51) Int. Cl. B25B 13/50

(52) U.S. Cl. 81/57.33

(57) ABSTRACT

Gripping apparatus comprises a plurality of axially tapered rollers (47) for engaging the gripped member; and a body having a cam surface (36) which is shaped so as to urge the rollers, when in use, against the gripped member when the rollers slide axially with respect to the cam surface. The cam surface is also shaped so as to urge the rollers, when in use, against the gripped member when the rollers roll along the cam surface.

The present invention relates to gripping apparatus.

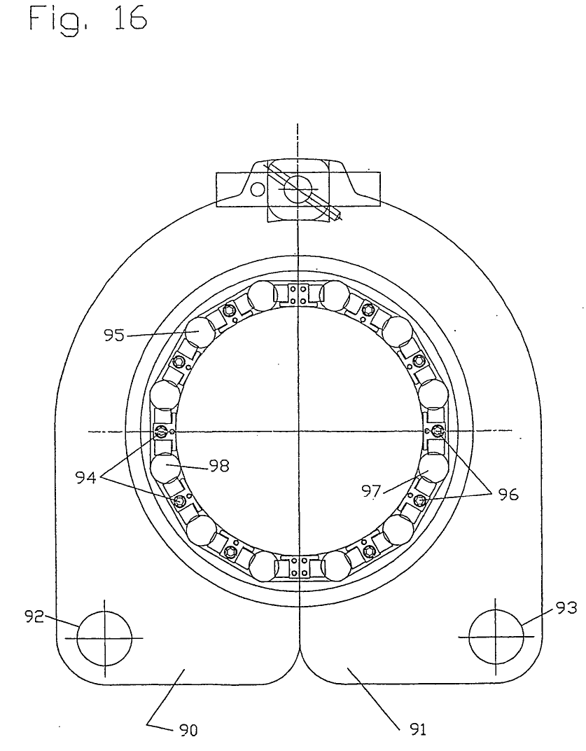

A conventional gripping apparatus is shown in FIG. 16, and described in detail in WO 01/21933. Jaws 90, 91 are pivotable about rods 92,93. Jaw 90 carries a semi-circular cage 94 containing rollers 95. Jaw 91 carries a semi-circular cage 96 containing rollers 97. The inner faces of the jaws 90,91 have recesses which receive the rollers 95,97.

When it is desired to grip tubular 98, The cages 94,96 are rotated relative to the jaws 90,91. This causes the rollers to roll along their respective recesses and become wedged between the tubular and the jaw.

A first aspect of the invention provides gripping apparatus comprising a plurality of rollers which taper axially from a relatively narrow end to a relatively wide end; and a body having a cam surface which is shaped so as to urge the rollers against a gripped member, when in use, when the rollers translate axially with respect to the cam surface, and which is also shaped so as to urge the rollers against the gripped member when the rollers roll along the cam surface.

The use of tapered rollers provides a number of advantages compared to the parallel-sides rollers described in WO 01/21933. Firstly, the rollers can provide resistance to both axial and rotational forces. Secondly, the system is more flexible because the rollers can be engaged in two different ways (that is, by sliding axially or by rolling). Thirdly, the apparatus can accommodate different gripped members with a wider variety of sizes. Fourthly, the rollers can be more densely packed because a smaller amount of rolling movement needs to be accommodated. Fifthly, axial engagement of the rollers can be achieved more easily using a linear drive device such as a hydraulic or pneumatic cylinder.

Preferably the apparatus further comprises an actuator for generating relative axial and/or rolling movement between the rollers and the cam surface to urge the rollers against the gripped member.

The actuator may engage the rollers and/or the cam surface. The cam surface or the rollers may remain stationary during the relative movement.

In a preferred embodiment, the rollers are moved by a cage coupled to a hand operated lever. Alternatively, the actuator may include a hydraulic or pneumatic cylinder.

Preferably the actuator comprises a plurality of resilient members, such as leaf springs, each coupled with a respective roller. The resilient members can then flex by different amounts if one of the rollers becomes stuck.

The angle of taper of the rollers may vary, but preferably is approximately constant along the length of the rollers.

The rollers may have a non-circular (e.g. elliptical) cross-section but typically are substantially circular in cross-section.

Most preferably the rollers are substantially frustoconical.

In one embodiment all of the rollers taper in the same direction. In another embodiment the direction of taper of the rollers alternates between successive rollers. This ‘top-and-tail’ arrangement permits the rollers to be packed more densely.

Typically the cam surface is formed with a plurality of recesses, each recess receiving a respective roller.

The body may comprise a single fixed piece, or may comprise two or more jaws which can be opened to admit the gripped member.

A second aspect of the invention provides apparatus for gripping a downhole tubular comprising gripping apparatus according to the first aspect of the invention.

The apparatus is particularly suited to such uses, in which the downhole tubular may be pipe casing, a drill string, or any other tubular associated with subterranean operations, typically in the oilfield industry.

For instance the apparatus may be of use in a power tong for gripping and rotating the downhole tubular, a backup for gripping and securing the downhole tubular against rotational movement, or in an elevator for securing the downhole tubular against axial and rotational movement.

A third aspect of the invention provides a socket wrench comprising gripping apparatus according to the first aspect of the invention. This provides an alternative application for the apparatus. In this case, the gripped member is an integral part of the apparatus, and comprises one or more sockets, typically hexagonal shaped.

A conventional method of gripping a downhole tubular is described in U.S. Pat. No. 5,845,549 and U.S. Pat. No. 4,084,453. Gripping members with sharp teeth are forced into engagement with the tubular. A problem with this method is that the teeth cause permanent deformation of the tubular. In certain circumstances this can present serious problems. For instance, in a sour gas well, corrosive gases such as Hydrogen Sulphide and Carbon Dioxide will be present. If the tubular is formed with a material such as Chromium, these gases will corrode the tubular more quickly if the tubular has a rough deformed surface.

A fourth aspect of the invention provides a method of handling a downhole tubular comprising gripping the tubular with a plurality of gripping members arranged circumferentially around the pipe; and transferring rotational and/or longitudinal forces to or from the tubular, wherein the tubular is gripped in such a manner so as not to exceed the elastic deformation limit of the tubular while the forces are being transferred.

The advantage of the fourth aspect of the invention is that it substantially avoids permanent deformation of the tubular.

Typically the method comprises urging the gripping members against the tubular by a wedging action. This wedging action tends to spread the gripping force over a relatively wide area, thus avoiding excessive deformation of the tubular.

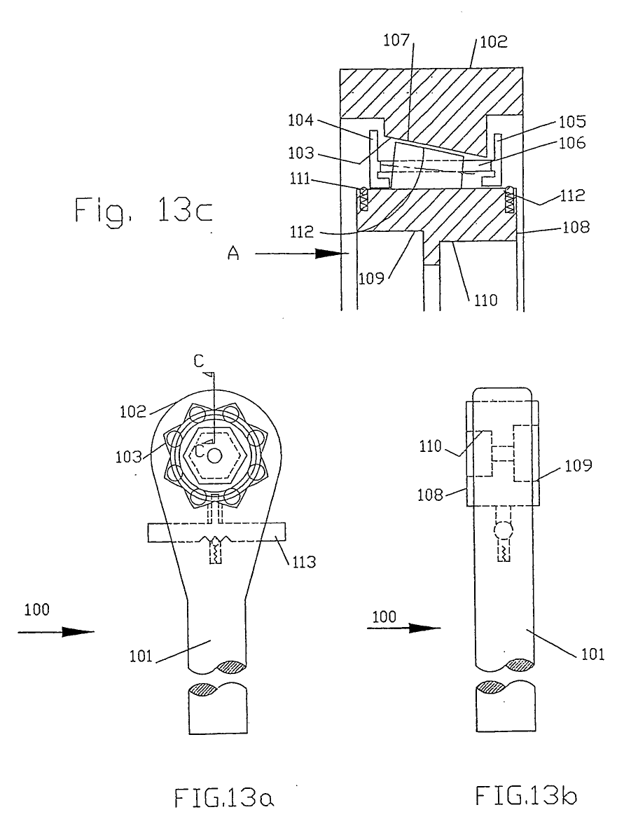

Typically the gripping member comprises a roller. The roller may have a wide variety of shapes including cylindrical, frustoconical, spherical or asymmetric—for instance the ‘dog bone’ shape shown in FIG. 13 of WO01/21933.

The gripping method may be employed during a variety of downhole operations. For example the tubular may be gripped while it is coupled (for instance by screwing) with an additional length of downhole tubular.

Typically the maximum deformation of the tubular is greater than 10% and less than 100% of the elastic limit.

A number of embodiments of the invention will now be described by way of example only and with reference to the accompanying drawings, in which:

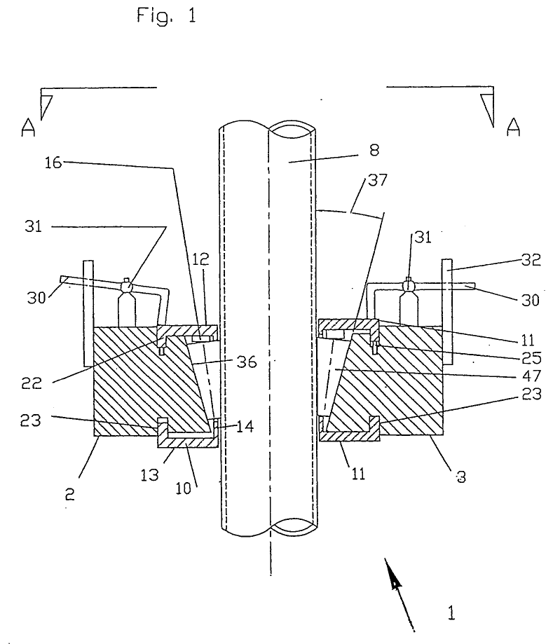

FIG. 1 is a sectional side view of a pipe string gripping mechanism;

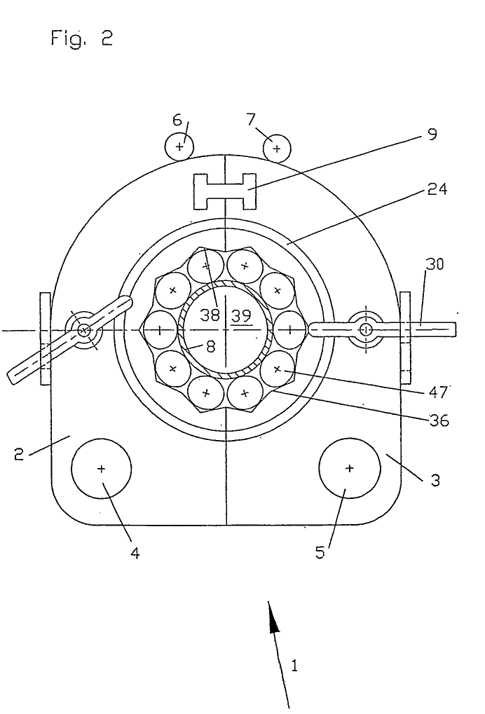

FIG. 2 is a cross-section taken along line A-A in FIG. 1;

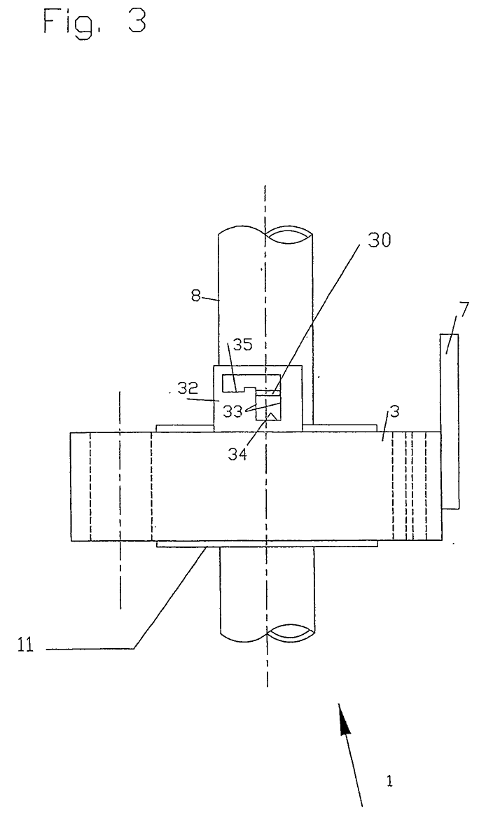

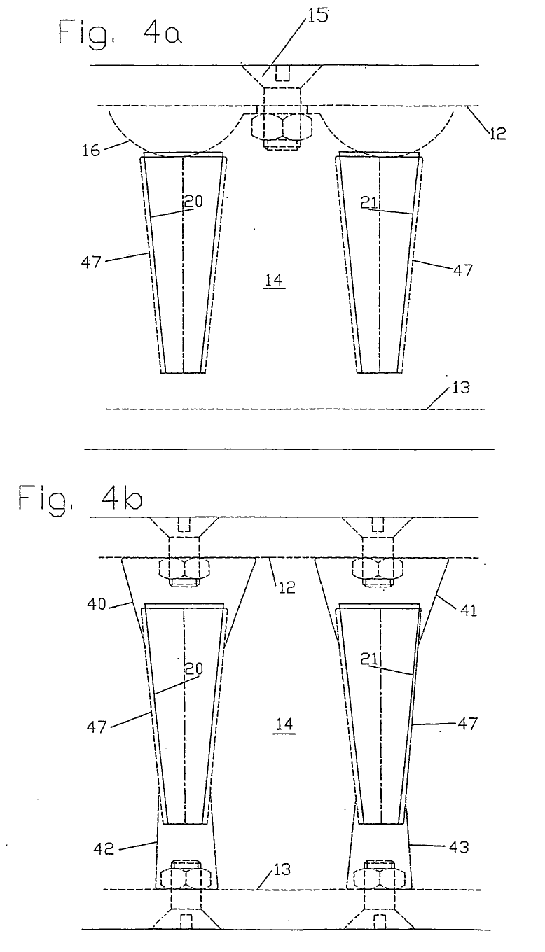

FIG. 3 is a side view of the mechanism from the right-hand side of FIG. 1 with the actuator handle in a partially raised position;

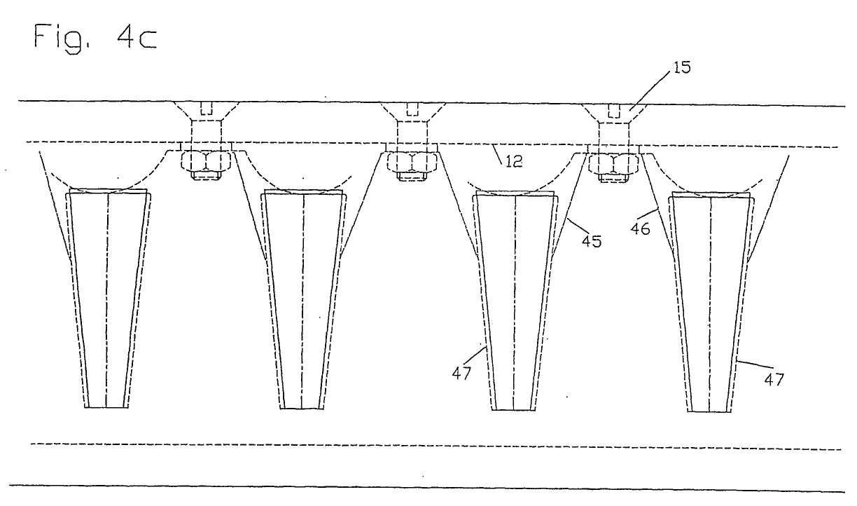

FIG. 4a is a view of the cage as viewed from inside the bore of the mechanism, with no pipe casing present;

FIG. 4b is a view of an alternative cage;

FIG. 4c is a view of a further alternative cage;

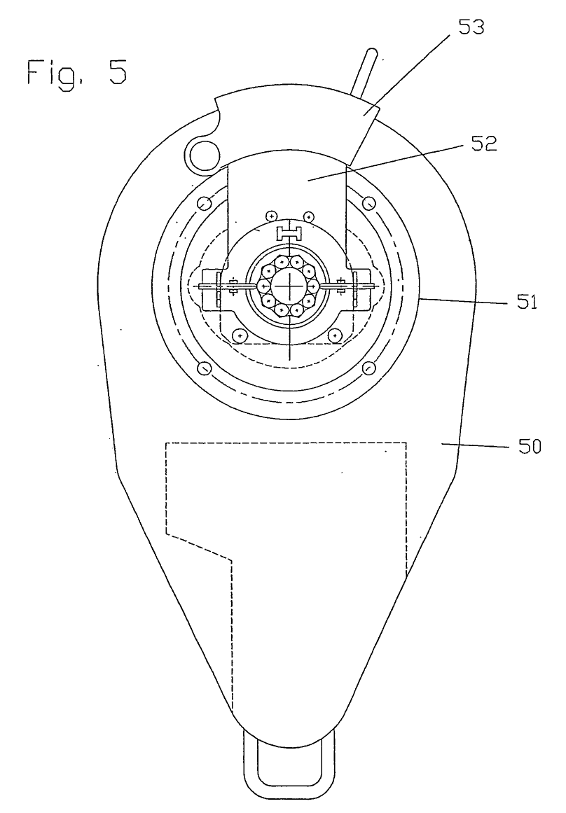

FIG. 5 is a plan view of an oil field tong incorporating the mechanism of FIGS. 1-4;

FIG. 5a is a plan view of an adapter plate;

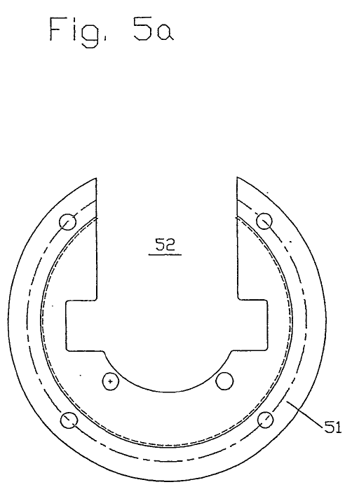

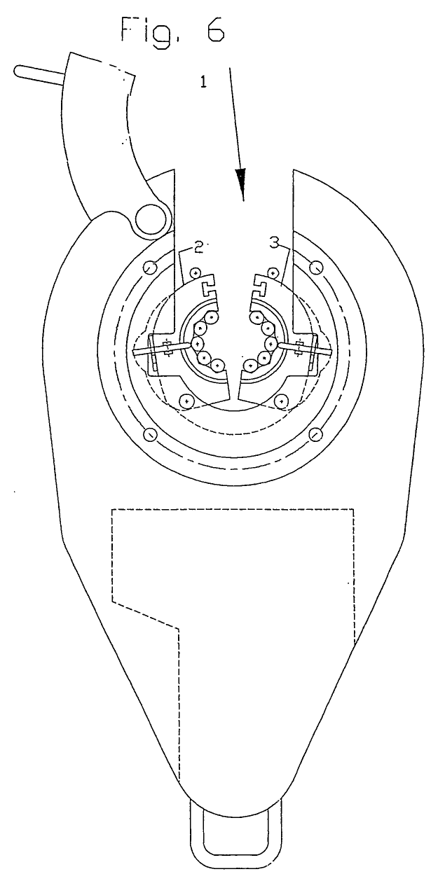

FIG. 6 shows the tong with the gripping jaws open;

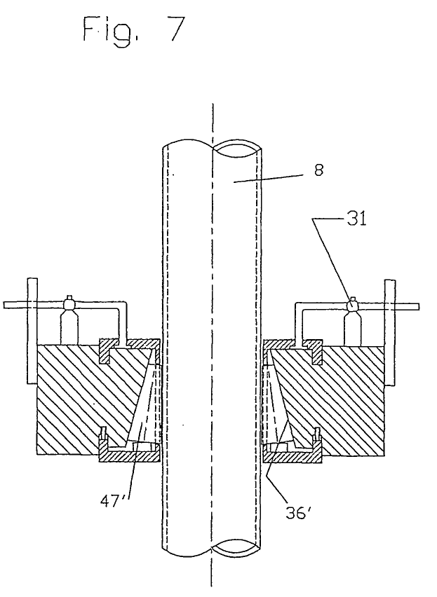

FIG. 7 is a sectional view of an alternative pipe string gripping mechanism with inverted rollers;

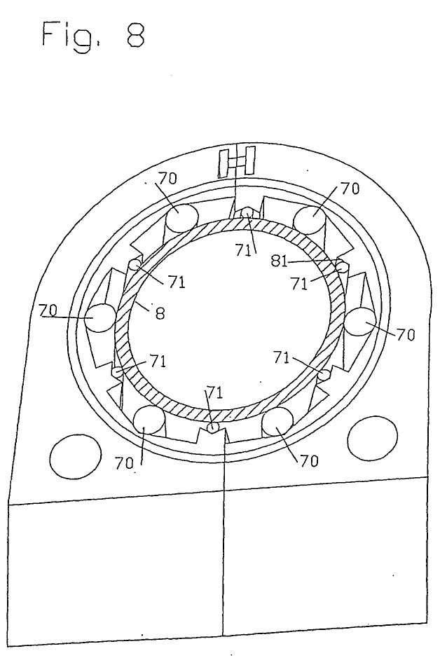

FIG. 8 is a perspective view of an alternative pipe string gripping mechanism with alternating rollers;

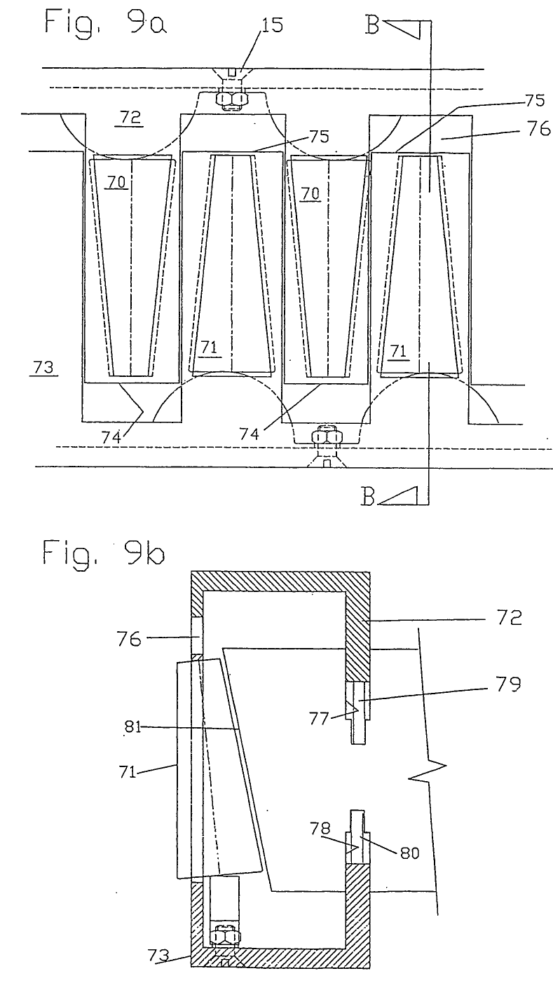

FIG. 9a is a view of the cage as viewed from inside the bore of the mechanism of FIG. 8, with no pipe casing present;

FIG. 9b is a section along line B-B in FIG. 9a;

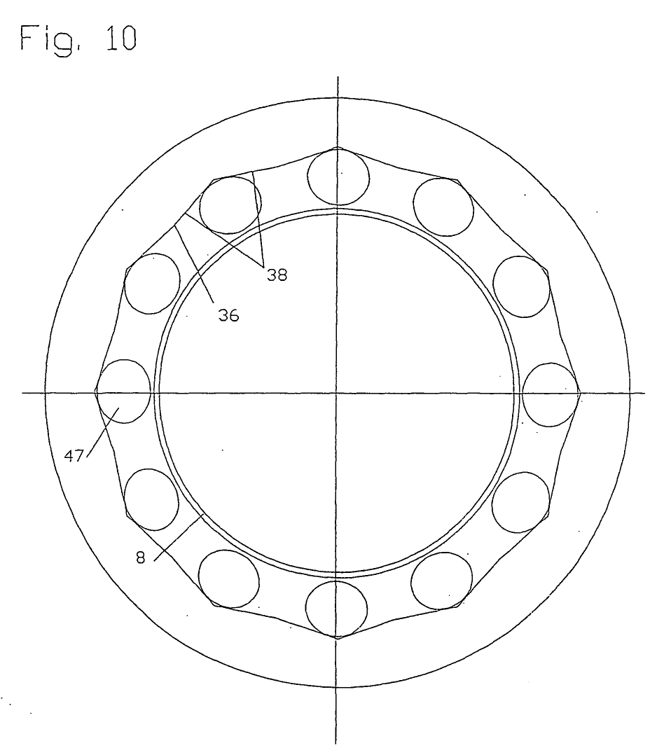

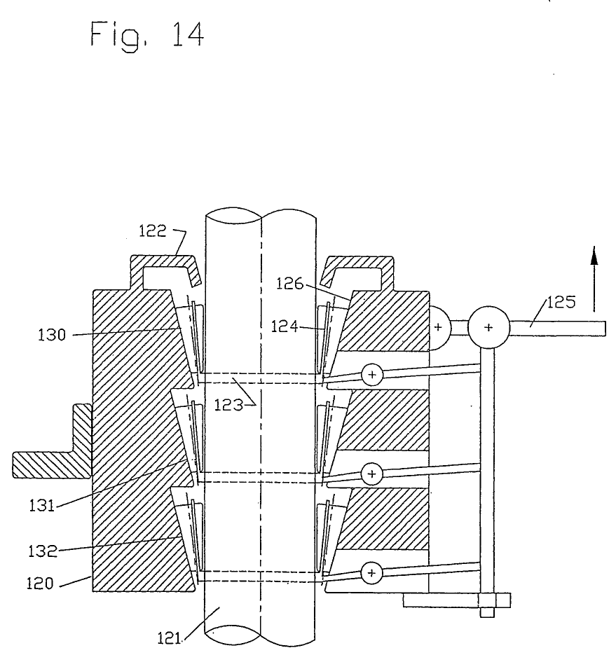

FIG. 10 is a simplified plan view of the mechanism of FIGS. 14 showing the rollers in their non-engaged position;

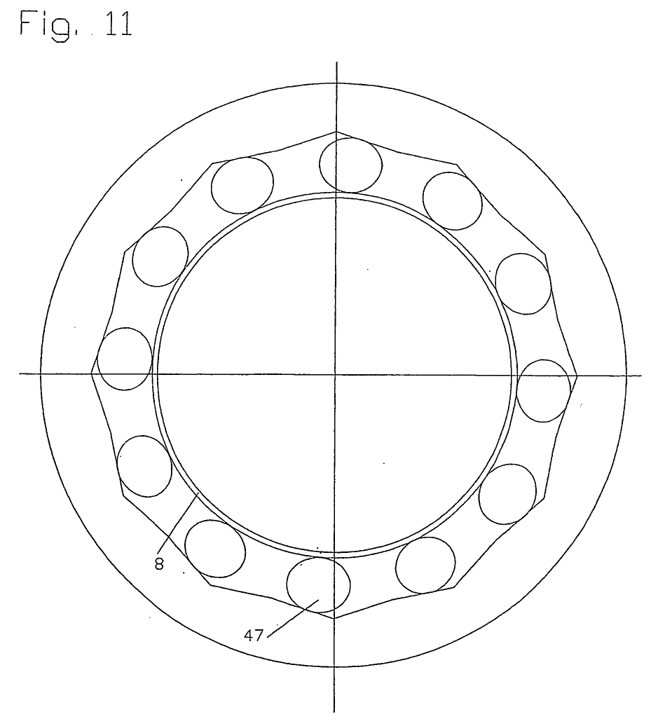

FIG. 11 shows the rollers after they have rolled into a partially engaged position;

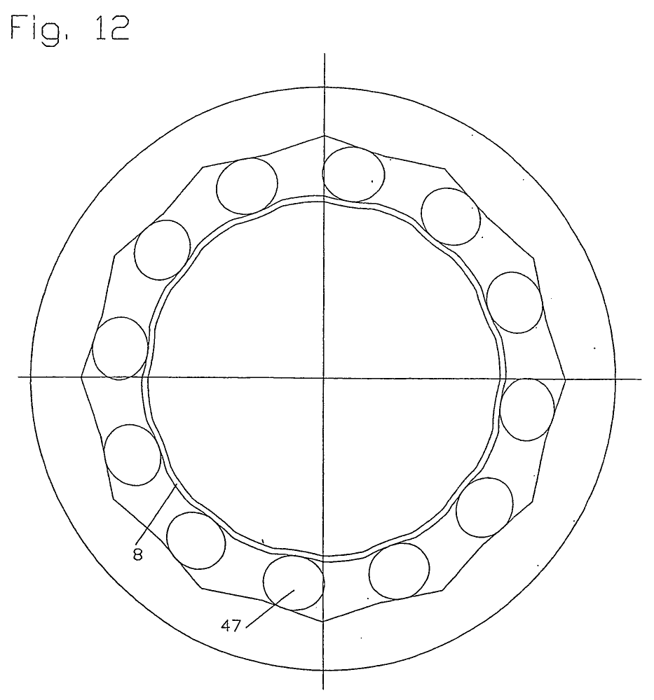

FIG. 12 shows the rollers in their fully engaged position and deforming the pipe string;

FIG. 13a is a front view of a hand held socket wrench;

FIG. 13b is a side view of the wrench of FIG. 13a;

FIG. 13c is a cross-section taken along line C-C in FIG. 13a;

FIG. 14 is a cross-sectional side view of a slip-type elevator; and

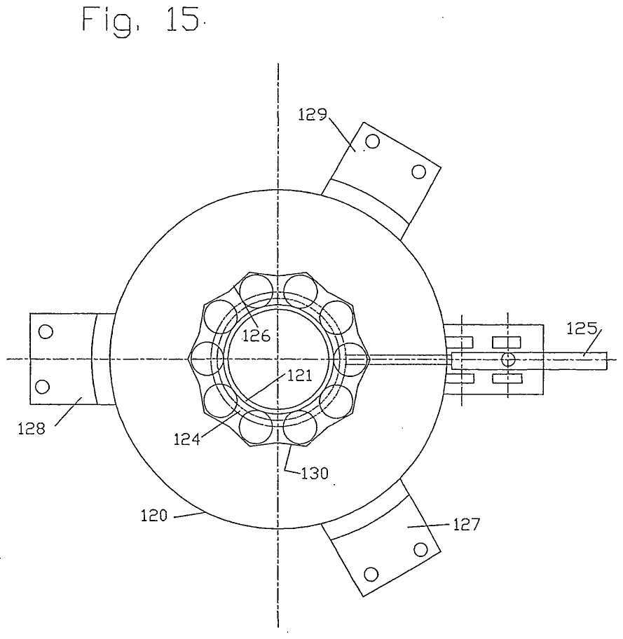

FIG. 15 is a plan view of the elevator of FIG. 14.

Referring to FIG. 2, a gripping mechanism designated generally at 1 comprises a pair of jaws 2,3 which are each mounted on respective pivot shafts 4,5. The jaws 2,3 can be pivoted apart by handles 6,7 to the open position shown in FIG. 6, in which a pipe string 8 can be introduced into the bore 39 between the jaws. The jaws are then closed and secured by means of a closing key 9.

Referring to FIG. 1, each jaw 2,3 carries a respective cage 10,11 (not shown in FIG. 2). The two cages are identical so only cage 10 will be described in detail. The cage 10 has a semi-cylindrical body portion 14 with upper and lower flanges 12,13. FIG. 4a shows the cage 10 as viewed from inside the bore between the jaws with the pipe string 8 removed. As shown in FIG. 4a, the upper flange 12 carries a fastener 15 which secures a leaf spring 16 to the underside of the flange 12. The leaf spring 16 has a pair of semicircular projections which each engage a relatively wide upper end of a respective roller 47 to apply a downward biasing force. The rollers 47 are frustoconical in shape and formed from 420 stainless steel. The rollers 47 each protrude partially through a respective tapered slot 20,21 which is slightly narrower than the rollers to prevent the rollers from passing through the slots. The relatively narrow lower ends of the rollers are biased against the base of the slots 20,21 by the leaf spring 16 to secure the rollers in place.

Referring to FIG. 1, the upper and lower flanges 12,13 each have guides 22,23 which are received in respective upper and lower cage grooves in the jaws 2,3. The upper cage groove 24 is shown in the plan view of FIG. 2. The upper cage groove 24 contains a return spring 25 shown in FIG. 1 which applies an upwards biasing force to the cage guide 22.

Each cage 10,11 can be driven downwards against the force of the return spring 25 by a respective actuation mechanism. Only the actuation mechanism driving cage 11 will be described. The mechanism comprises an L-shaped actuation arm 30 pivotally mounted to the jaw 3 by a rose joint 31. Referring to FIG. 3, a plate 32 fixed to the jaw 3 has an L-shaped slot 33 which receives the actuation arm 30. To drive the cage 11 down to its engaged position, the actuation arm 30 is lifted up from the position shown in FIG. 1 (in which the arm engages the lower face 34 of the slot 33), then rotated until the arm 30 engages face 35 of slot 33. The arm 30 pushes down onto the cage to drive it to the lowered, engaged position. For illustration, the cage 10 (and its associated actuation mechanism) is shown in its engaged position in FIG. 1 and the cage 11 is shown in its unengaged position.

As the roller 47 slides axially down to its engaged position, the correspondingly tapered inner cam surface 36 of the jaw 2 wedges the roller against the pipe string. This secures the pipe string against relative axial movement.

Preferably the internal angle of taper 37 of the cam surface 36 and the roller is greater than 0 degrees and less than 60 degrees. More preferably the internal angle of taper 37 is in the range of 3 to 5 degrees. The angle of taper is exaggerated in the drawings for purposes of illustration.

The cam surface 36 is formed with a series of V-shaped recesses 38 arranged around the circumference of the bore 39 which receive the rollers, as shown in the plan view of FIG. 2. These recesses act to urge the rollers against the pipe string as described below with reference to FIGS. 10-12. In the non-engaged position of FIG. 10 the rollers 47 are each centered in their respective recesses 38 in the cam surface 36. If a torque is applied to the pipe string (or equivalently if the cages are rotated) the rollers will roll around the pipe string 8. As the rollers move, they are urged by the cam surface towards the pipe string to the position shown in FIG. 11 in which they engage the pipe string. As the rollers continue to move, they are wedged into the pipe string and cause the pipe string to deform as shown in FIG. 12. Such deformation could be measured, for example, by a strain gauge attached to the inner or outer circumference of the pipe string.

However, the pipe string only needs to deform a small amount in order to fly grip the rollers. Therefore, the pipe casing 8 is not deformed beyond its elastic deformation limit (either during initial gripping or when the pipe casing is being rotated) and when the rollers are released to the non-engaging position of FIG. 10, the pipe casing 8 relaxes back to its undeformed state.

It will be appreciated that the range of movement of the rollers 47, and the degree of deformation of the pipe string 8, have both been exaggerated in FIGS. 10-12 for purposes of illustration.

The actuation mechanism shown in FIGS. 1-3 drives the cages downwards to engage the rollers with the pipe string. An advantage of this arrangement is that a wide variety of pipe string diameters can be accommodated by varying the range of movement of the cages.

In an alternative arrangement illustrated in FIG. 4b, the cages are rotated by alternative actuation mechanisms (not shown) to engage the rollers with the pipe string. In this case, the leaf spring 16 is replaced with upper leaf springs 40,41 and lower leaf springs 42,43. The leaf springs 40-43 each have a respective base secured to a cage flange 12/13 and a pair of arms which grip opposite sides of the roller. When the cage is rotated, force is applied to the rollers by the spring arms, causing the rollers to roll round the pipe string.

In a further alternative arrangement, two different actuation mechanisms (not shown) are provided-one to drive the rollers downwards, and another to rotate the rollers. The roller mounting system for such a mechanism is shown in FIG. 4c. Each fastener 15 secures leaf spring 16 to flange 12. Each fastener 15 also secures a second leaf spring having a base and two arms 45,46 which each apply a sideways biasing force to a respective different roller.

Referring to FIGS. 5, 5a and 6—the gripping mechanism 1 is mounted, in use, in a tong 50. The mechanism 1 is housed between a pair of adapter plates 51. Pipe string 8 is introduced by opening gate 53 and jaws 2,3 (see FIG. 6) and moving the pipe string 8 laterally into throat 52.

In use, an existing pipe string (not shown) is received in a borehole and axially supported by a slip elevator (not shown). In order to attach an additional length of pipe string 8, the existing pipe string is secured against torque by a set of backup jaws (not shown) and the additional length 8 is gripped by the tong 50 and screwed into the existing pipe string. Large torques are required to ensure a gas tight seal between the coupled lengths of pipe string.

It will be appreciated that the mechanism of FIGS. 1-3 can be inverted as shown in FIG. 7. In this case the angle of taper of the rollers 47′ and cam surface 36′ are reversed, and the cages are pulled upwards by their respective actuation mechanisms.

In a further alternative arrangement shown in FIGS. 8, 9a and 9b, the rollers are ‘top-and-tailed’. Specifically, there are six downwardly directed rollers 70 which alternate with six upwardly directed rollers 71. Referring to FIGS. 9a and 9b: the downwardly directed rollers 70 are mounted in a first cage 72 and the upwardly directed rollers 71 are mounted in a second cage 73. The cage 72 has a series of downwardly pointed fingers 74 and the cage 73 has a series of upwardly pointed fingers 75 which interlock with the fingers 74. Windows 76 are provided to allow relative axial movement between the two sets of fingers.

Each cage is driven up or down by a respective actuation mechanism (not shown), and is mounted in a respective cage groove 77,78 containing a return spring 79,80, shown in FIG. 9b.

The rollers 71 are urged against the pipe casing by a correspondingly tapered cam surface 81 with a V-shaped recess shown in FIG. 8, and the rollers 70 are urged against the pipe casing by a similar cam surface (not shown).

An advantage of the arrangement of FIGS. 8-9b is that the rollers can be more densely packed than in the arrangement of FIG. 1.

Referring to FIGS. 13a-13c, a socket wrench designated generally at 100 has a handle 101 and a head 102 having a bore defined by a cam surface 103 shown most clearly in FIG. 13c. A cage mounted in the bore comprises a cylindrical body portion 106 with a pair of flanges 104,105. The body portion 106 has eight tapered windows which each receive a respective tapered roller 107.

A generally cylindrical socket member 108 is formed with a large hexagonal socket 109 on one side and a small hexagonal socket 110 on the other side. The member 108 has a series of holes arranged around its periphery each housing a coil spring and indent ball 111,112.

The rollers 107 can be engaged with the member 108 in two ways. In one alternative, by pushing the member 108 with the thumb in a direction indicated by arrow A (while holding the handle 101 still), the member 108 moves the indent ball 111 which engages the cage flange 104. The cage then engages the rollers 107 and slides them along cam surface 112. The cam surface 112 forces the rollers against the member 108 to lock the member 108 in place. A nut can then be received in either of the sockets 109,110 and rotated by rotating the handle 101 in either direction. The rollers can be disengaged by pushing the member 108 in the opposite direction to arrow A with the thumb.

In a second alternative, the rollers can be engaged by rotating the cage with an actuating handle 113. The handle 113 can be moved to the left or right (as viewed in FIG. 13a). The cam surface 103 is formed with V-shaped recesses shown in FIG. 13a which urge the rollers 107 against the member 108 when the cage is rotated.

A slip type elevator is shown in FIGS. 14 and 15. The elevator has a generally cylindrical body portion 120 which is formed as a single piece, and is not split and hinged as in the tong mechanism shown in FIGS. 1-7. The body portion has a bore which receives a pipe string 121. The pipe string 121 is gripped by thirty rollers, arranged as three layers of ten rollers. The upper layer of ten rollers 130 is shown in the plan view of FIG. 15. Two rollers in each layer 130,131,132 are shown in the sectional view of FIG. 14.

The upper layer of rollers 130 is confined by a guide 122 shown in FIG. 14 but omitted from FIG. 15 for clarity. Each layer of rollers is supported by a respective cage comprising a circular ring 123 and flange 124 which is formed with a series of tapered slots (not shown) which receive the rollers. The three cages are each coupled to a handle 125. When the handle 125 is lifted up, the cages are lowered which allows the rollers to drop due to gravity. As the rollers slide down they are forced by respective cam surfaces 126 against the pipe string 121. The weight of the pipe string 121 can then be supported by the rollers. The weight forces are transferred to the body portion 120 which is attached to a rig floor (not shown) by three supports 127,128,129 shown in FIG. 15. In an alternative arrangement (not shown) the weight forces may be transferred to bails by lugs.

If the pipe string 121 is rotated, the rollers roll up their V-shaped recesses in the cam surface (shown in FIG. 15) and are forced against the pipe string, thus resisting the rotational movement.

The mechanism shown in FIGS. 1-13 (with a single row of rollers) is able to transfer axial load and torque. However, the ability to transfer axial load is increased when torque is also present. Where the mechanism is employed in a slip elevator, then torque may not be present. This is why multiple rows of rollers are present in the embodiment of FIGS. 14, 15: to provide increased ability to resist axial loads in the absence of torque, whilst not deforming the pipe casing beyond its elastic deformation limit. Although only three rows of rollers are shown in FIG. 14, a larger number of rows (for instance fifteen) may be employed if necessary.

1. Gripping apparatus comprising a plurality of rollers which taper axially from a relatively narrow end to a relatively wide end; and a body having a cam surface which is shaped so as to urge the rollers against a gripped member, when in use, when the rollers translate axially with respect to the cam surface, and which is also shaped so as to urge the rollers against the gripped member when the rollers roll along the cam surface.

2. Apparatus according to claim 1 further comprising an actuator for generating relative movement between the rollers and the cam surface to urge the rollers against the gripped member.

3. Apparatus according to claim 2 wherein the actuator is configured to generate relative axial movement between the rollers and the cam surface.

4. Apparatus according to claim 2 wherein the actuator is configured to generate relative rolling movement between the rollers and the cam surface.

5. Apparatus according to claim 2, wherein the actuator engages the rollers.

6. Apparatus according to claim 5 wherein the actuator comprises a plurality of resilient members, each coupled with a respective roller.

7. Apparatus according to claim 1 wherein the angle of taper of the rollers is approximately constant along the length of the rollers.

8. Apparatus according to claim 1 wherein the rollers are substantially circular in cross-section.

9. Apparatus according to claim 7 wherein the rollers are substantially frustoconical.

10. Apparatus according to claim 1 wherein the direction of taper of the rollers alternates between successive rollers.

11. Apparatus according to claim 1 wherein the cam surface is formed with a plurality of recesses, each recess receiving a respective roller.

12. Apparatus according to claim 1 wherein the body comprises two or more jaws which can be opened to admit the gripped member.

13. Apparatus according to claim 1, wherein the rollers are spaced axially with respect to each other.

14. Apparatus according to claim 13 wherein the rollers are arranged in two or more axially spaced rows.

15. Apparatus for gripping a downhole tubular comprising gripping apparatus according to claim 1.

16. Apparatus according to claim 15 wherein the apparatus is a power tong for gripping and rotating the downhole tubular.

17. Apparatus according to claim 15 wherein the apparatus is a backup for gripping and securing the downhole tubular against rotational movement.

18. Apparatus according to claim 15 wherein the apparatus is an elevator for securing the downhole tubular against axial and rotational movement.

19. A socket wrench comprising gripping apparatus according to any of claim 1.

20. A method of handling a downhole tubular comprising gripping the tubular with a plurality of gripping members in the form of tapered rollers arranged circumferentially around the pipe; and transferring rotational and/or longitudinal forces to or from the tubular, wherein the tubular is gripped in such a manner so as not to exceed the elastic deformation limit of the tubular while the forces are being transferred.

21. The method of claim 20 further comprising the step of urging the gripping members against the tubular by a wedging action.

22. The method of claim 20, wherein the gripping apparatus is gripping apparatus according to claim 1.

23. The method of claim 20 further comprising the step of coupling the downhole tubular to an additional length of downhole tubular.

24. The method of claim 20 wherein the maximum deformation of the tubular lies in a range greater than 10% of the elastic limit of the tubular and less than 100% of the elastic limit of the tubular.

25. The method of claim 20, comprising gripping the tubular with three or more gripping members.

26. The method of claim 20, wherein the gripping members are metallic.
